(19) United States
(12) Patent Application Publication
(10) Pub. No.: US 2022/0281778 A1
(43) Pub. Date: Sep. 8, 2022

(54) Sulfur and Ammonia Irrigation

(71) Applicant: Grimm's Gardens, L.L.C., Hiawatha, KS (US)

(72) Inventors: Kurt D. Grimm, Hiawatha, KS (US); Koertland Beyer, Sabetha, KS (US)

(73) Assignee: Grimm's Gardens, L.L.C., Hiawatha, KS (US)

(21) Appl. No.: 17/652,317

(22) Filed: Feb. 24, 2022

Related U.S. Application Data
(60) Provisional application No. 63/200,331, filed on Mar. 2, 2021.

(51) Int. Cl. C05C 3/00; C05G 5/23; A01C 23/04; A01C 21/00

(52) U.S. Cl. CPC C05C 3/00; C05G 5/23; A01C 23/042; A01C 21/00

(57) ABSTRACT

A method for applying a liquid fertilizer with a liquid fertilizer manufacturing system is disclosed. The method includes the steps of providing a liquid fertilizer manufacturing system, injecting an ammonia into a sulfurous acid to form the liquid fertilizer, and transferring the liquid fertilizer to an irrigation system. The liquid fertilizer manufacturing system contains a liquid fertilizer generator having an upstream portion and a downstream portion. A sulfurous acid injection port is fluidly connected to a sulfurous acid source that is disposed in the upstream portion of the liquid fertilizer generator. An ammonia injection port is fluidly connected to an ammonia source to in an ammonia into the liquid fertilizer generator. An aerator may be disposed downstream of the ammonia injection port. A withdraw port disposed in the downstream portion of the liquid fertilizer generator is fluidly connected to an irrigation system.

### CROSS REFERENCES

This application claims priority of U.S. Provisional Application No. 63/200,331 filed 2 Mar. 2021.

### FIELD OF THE INVENTION

The present disclosure relates to a method and system designed for manufacturing a liquid fertilizer from a nitrogen-containing ammonia and a sulfurous acid treatment; and on-site manufacturing means utilizing a portable fertigation system connected to open or closed distribution systems for field or agricultural fertigation.

### BACKGROUND

Ammonium sulfur fertilizers, comprising ammonium sulfur compounds such as ammonium sulfite, having a chemical formula of (NH₄)₂SO₃, and ammonium sulfate (AMS), having a chemical formula of (NH₄)₂SO₄, may be applied to fields, such as fields with alkaline soils. AMS, a preferred soil fertilizer, is an inorganic sulfate salt, containing 21% nitrogen (N) and 24% sulfur (S), which may be obtained by reaction of sulfuric acid with ammonia. Ammonia sulfite is an ammonium salt which may be obtained by reaction of sulfurous acid with ammonia. Ammonium sulfur fertilizers has several commercial uses including application to fields as a dry fertilizer product. Typically, agricultural farmers use dry AMS on fields. The farmers are seeing benefits including increased plant health and harvest yield.

Traditionally, ammonium sulfur fertilizers such as AMS may be manufactured using filtered, distilled, or other purified water. The synthesized sulfuric acid is made then introduced with ammonia (NH₃) to make a conversion into a crystallized AMS product. The AMS product is dehydrated into a mineral salt that is shipped to the farmer. The applicator may then apply the AMS as a granular fertilizer product by driving a fertilizer spreader over the field. An applicator may apply the dry AMS as part of a liquid fertilizer product. The applicator in this scenario would hydrate the AMS to dissolve the inorganic ammonium sulfate salt into solution.

In addition to applying ammonium sulfur fertilizers, farmers may also irrigate their fields with irrigation systems, such as with pivot irrigators or subsurface drip irrigation. Anhydrous ammonia (NH₃) may be injected into a piped irrigation system, called nitrogen chemigation or fertigation. The resulting liquid fertilizer may then be pumped or allowed to drain into an open irrigation system to fertilize a field.

### SUMMARY

A method for applying a liquid fertilizer is disclosed including the following steps: (1) providing an onsite liquid fertilizer manufacturing system; (2) injecting ammonia into sulfurous acid (preferred acid source), sulfuric acid, phosphoric acid, and/or nitric acid to form the liquid fertilizer within the liquid fertilizer manufacturing system; (3) transferring the liquid fertilizer from the liquid fertilizer manufacturing system to an irrigation system; and (4) applying the liquid fertilizer to a field through the irrigation system.

The method for applying the liquid fertilizer may also include the following optional steps: (a) injecting an oxidizing agent under pressure into the liquid fertilizer manufacturing system; (b) recirculating the liquid fertilizer from a liquid fertilizer generator back through the liquid fertilizer manufacturing system; (c) transferring the liquid fertilizer from the liquid fertilizer manufacturing system to a tank; (d) returning the liquid fertilizer from the tank to the liquid fertilizer manufacturing system with a pump; (e) generating sulfurous acid within the liquid fertilizer manufacturing system by injecting sulfur dioxide into a liquid, wherein the liquid is from a liquid source selected from a list of well water, pond water, runoff water, agricultural runoff, feedlot runoff, treated wastewater, and a combination thereof; (f) applying the liquid fertilizer in less than 24 hours from initiating the step of injecting the ammonia into the sulfurous acid; (g) directing a first flow of the acid through a liquid fertilizer generator in a downstream direction; and (h) directing a second flow of the ammonia through the liquid fertilizer generator within the first flow of the sulfurous acid.

The liquid fertilizer may include an oxidizing agent from an oxidizer source such as: air, oxygen, ozone, hydrogen peroxide, and a combination thereof. In the step of injecting the oxidizing agent, the oxidizing agent may be injected into the acid prior to the step of injecting the ammonia. The ammonia may be from an ammonia source such as: ammonia gas, anhydrous ammonia, a solution of aqueous ammonia, an organic form of ammonia, and a combination thereof.

The liquid fertilizer formed by a reaction in the liquid fertilizer manufacturing system may be non-biological. The liquid fertilizer manufacturing system may be fluidly connected to the irrigation system with a pump. The irrigation system may be selected from a list of flood irrigation systems, furrow irrigation systems, drip irrigation systems, pivot irrigation systems, and sprinkler irrigation systems. The liquid fertilizer manufacturing system may be a portable unit. The ammonia may be injected in an offset direction to a flow of the acid. The ammonia may be injected in a same direction to a flow of the acid.

A liquid fertilizer manufacturing system is disclosed and contains a liquid fertilizer generator having an upstream portion, a downstream portion, an acid injection port fluidly connected to an acid source that is disposed in the upstream portion of the liquid fertilizer generator, an ammonia injection port configured to receive an ammonia from an ammonia source into the liquid fertilizer generator, an aerator disposed downstream of the ammonia injection port, and a withdraw port disposed in the downstream portion of the liquid fertilizer generator and fluidly connected to an irrigation system.

The liquid fertilizer manufacturing system may contain an aerator that is an air stone, diffuser, or bubbler type device fluidly connected to the ammonia injection port disposed in the downstream portion of the liquid fertilizer generator. The withdraw port may be configured to dispense a liquid fertilizer from the liquid fertilizer generator to the irrigation system. An irrigation injection port may be fluidly connected to the withdraw port and configured to inject the liquid fertilizer into the irrigation system.

The liquid fertilizer manufacturing system may further contain a sulfur burner system having a sulfur burner, a reaction chamber fluidly connected to the sulfur burner and fluidly connected to a liquid source, and a tank fluidly connected to and disposed below the reaction chamber, and where the tank receives a sulfurous acid descending from the reaction chamber. The tank may have a liquid receiving port that receives the sulfurous acid and an acid transfer port that dispenses the sulfurous acid from the tank. The liquid fertilizer manufacturing system may further contain an oxidizing injection port between the acid transfer port and the acid injection port. The oxidizing injection port may be fluidly connected to an oxidizer source to introduce an oxidizing agent into the liquid fertilizer manufacturing system. The ammonia may be injected into the sulfurous acid with a counter current flow upstream of the withdraw port. The liquid fertilizer manufacturing system may be portable.

A method for making a liquid fertilizer is disclosed including the following steps: (1) first, injecting an acid into a liquid to form an acidified liquid, where the acidified liquid contains an element selected from a list of nitrogen, phosphorous, potassium, and sulfur; (2) second, injecting a base into the acidified liquid to form the liquid fertilizer, where the base is gaseous and contains an element selected from the list of nitrogen, phosphorous, potassium, and sulfur; and optionally (3) applying the liquid fertilizer to a field through an irrigation system. The acid may be injected into a liquid that is alkaline. In the step of injecting, the acid being injected into the liquid that is alkaline may remove carbonates and bicarbonates.

Advantages to this method and system may include a reduction in the loss of anhydrous ammonia to volatilization and denitrification. This portable manufacturing and delivery system produces fertilizer that provides plant available nutrients, including sulfur and nitrogen, in their cheapest form on-site. The sulfur and nitrogen can be made readily available to plants in a form for plant uptake. Also, when used by a pivot irrigation system, the nitrogen source for plants may be applied upon connection to a liquid fertilizer manufacturing system on-site. This may result in a decrease in application costs, implement compaction to soil, fuel usage, and time constraints for application.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### BRIEF DESCRIPTION OF DRAWINGS

Aspects are illustrated by way of example, and not by way of limitation, in the accompanying drawings, wherein:

FIG. 1A shows a side perspective view of a liquid fertilizer manufacturing system;

FIG. 1B shows a side perspective view of a liquid fertilizer manufacturing system;

FIG. 2 shows a simplified, cutaway view of a liquid fertilizer generator in a horizontal orientation having input flows at offset directions;

FIG. 3 shows a simplified, cutaway view of a liquid fertilizer generator in a horizontal orientation having interior baffles and input flows with the same direction;

FIG. 4 shows a simplified, cutaway view of a liquid fertilizer generator in a horizontal orientation with an input flow from an oxidizing agent source;

FIG. 5 shows a schematic plan for an on-site liquid fertilizer manufacturing system;

FIG. 6 shows a flowchart for applying a liquid fertilizer; and

FIG. 7 shows a flowchart for making a liquid fertilizer.

### DETAILED DESCRIPTION

The liquid fertilizer manufacturing system 100 may transfer a liquid fertilizer 147 to an irrigation system 149. The liquid fertilizer 147 may be produced in a liquid fertilizer generator 141 and transferred directly to the fluidly connected irrigation system 149. The liquid fertilizer manufacturing system 100 provided may be a portable unit 148 and used at a field 150. The liquid fertilizer 147 is applied to the field 150 by the irrigation system 149. Alternatively, the liquid fertilizer 147 may be recirculated back through the liquid fertilizer manufacturing system 100 to increase concentrations. An application of the liquid fertilizer 147 may occur in less than 24 hours from injecting an ammonia 137 into an acid. A liquid source 102 may be provided at the field 150 for formation of the liquid fertilizer 147.

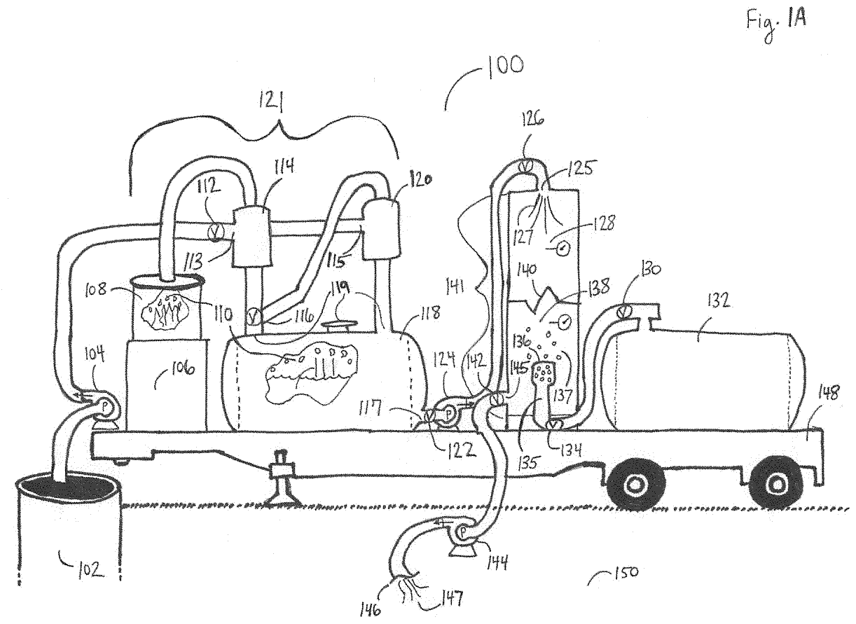

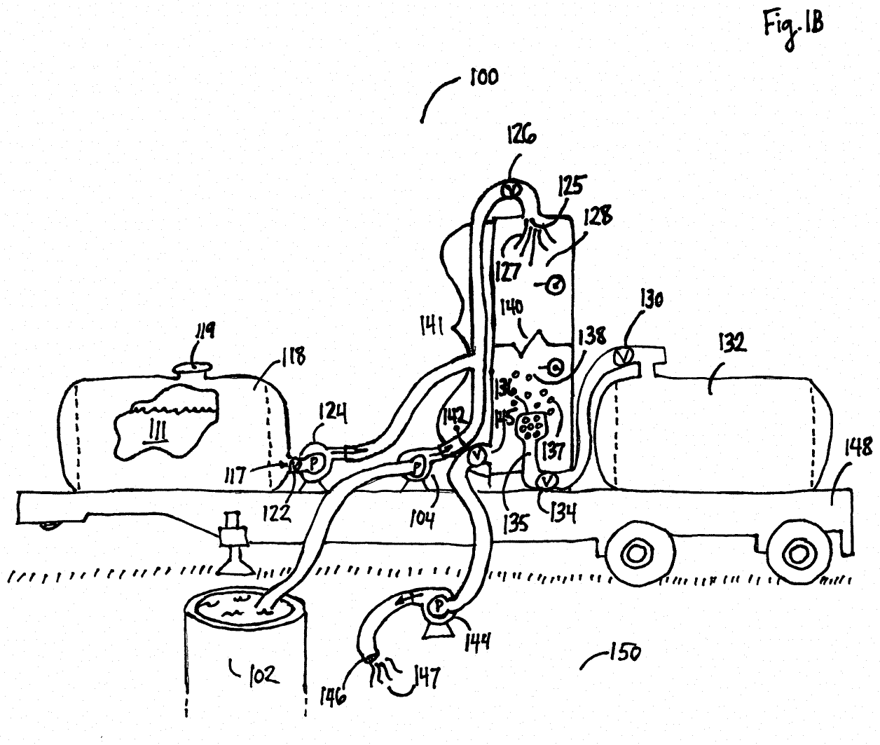

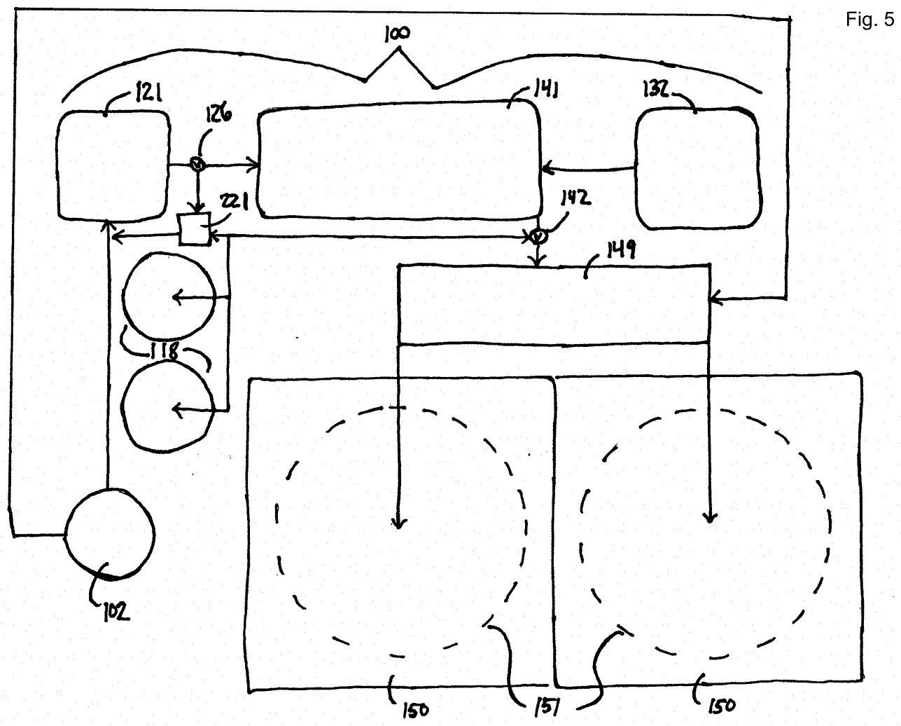

As shown in FIGS. 1A, 1B, and 5 the liquid fertilizer manufacturing system 100 is fluidly connected to the liquid source 102. The liquid source 102 may contain well water, pond water, runoff water, agricultural runoff, feedlot runoff, treated wastewater, and a combination thereof. The liquid source 102 may or may not provide a liquid that is alkaline and/or contains ammonia 137. An alkaline liquid may contain carbonates and bicarbonates that react when injecting an acid into the alkaline liquid. The now acidified liquid may be injected with a base to form the liquid fertilizer 147. Any precipitation or mineral deposits in the previously alkaline liquid are limited or eliminated during the formation of the liquid fertilizer 147 that passes through the irrigation system 149.

The liquid may be pumped directly from the liquid source 102 and/or tank 118 when transferred. A tank 118 may be used for holding the liquid from the liquid source 102 until it is introduced into the liquid fertilizer manufacturing system 100. The volume of the tank 118 may be 500 gallons, 1000 gallons, 2000 gallons, larger or smaller. The tank 118 may be fluidly connected to a liquid source pump 104 with piping, and a valve, such as a y-gate valve. The liquid source pump 104 may be used to transfer the liquid from the liquid source 102 and/or the tank 118 to a sulfur burner system 121.

As depicted in FIG. 1A, the liquid fertilizer manufacturing system 100 may generate a sulfurous acid 127 via a fluidly connected sulfur burner system 121 or an acid source, such as a sulfurous acid source 111, may be provided. Purchasing and connecting the sulfur burner system 121 may be a more viable option when the irrigation operations are conducted on a larger scale. Purchasing and transporting the acid source may be a more viable option when the irrigation operations are conducted on a smaller scale. In situations where a field 150 is smaller, for example 40 acres or less, acid may be purchased and transported to the liquid fertilizer manufacturing system 100 for use as the acid source. Tank 118 may be the holding container for the acid source supplied as depicted in FIG. 1B. The acid may be sulfurous acid (H₂SO₃), phosphoric acid (H₃PO₄), nitric acid (HNO₃), and/or sulfuric acid (H₂SO₄). Sulfuric acid may be the preferred acid source for smaller operations.

The sulfur burner system 121 may be a system comparable to the Agua Dulce Sweetwater Sulfur Burner, the Harmon SO₂ Generator, or the Automated Sulfur Burner for Agricultural Irrigation described in U.S. Pat. No. 10,457,578 B1. Sufficient flow of the liquid may be directed towards the sulfur burner system 121 through a first valve 112. The liquid fertilizer manufacturing system 100 may include the first valve 112, such as a y-gate valve, to separate the flow of liquid into several streams. The streams of liquid may then enter a plurality of reaction chambers 114, 120 of the sulfur burner system 121. A first reaction chamber 114 and a second reaction chamber 120 may also receive a flow of sulfur dioxide 110. The sulfur dioxide 110 may be produced from burning elemental sulfur (S) within a sulfur burner 108 in the presence of oxygen (O₂). The chemical reaction may produce a sulfur dioxide (SO₂) gas. The sulfur burner 108 may be sized to produce a needed volume of sulfur dioxide 110 for a desired amount of sulfurous acid 127. The sulfur burner 108 may be configured and connected to a sulfur feeder 106 or hopper to manage the flow of elemental sulfur into the sulfur burner 108.

The reaction chambers may produce a sulfurous acid 127 (H₂SO₃) that is aqueous when the SO₂ 110 gas and the stream(s) of liquid, such as water (H₂O), are jointly injected into liquid fertilizer manufacturing system 100. The reaction chambers 114, 120 may be designed as a venturi. The venturi design may comprise an inner pipe for the sulfur dioxide 110 to flow through and an outer pipe with a gasket having holes. The gasket may be an ethylene propylene diene monomer (EPDM) gasket. The gasket having holes creates a liquid jacket around the flow of sulfur dioxide 110 until both are introduced together in a first cycle through the first reaction chamber 114 of the sulfur burner system 121. Alternatively, the stream of liquid may be sprayed into the reaction chambers 114, 120 with spray nozzles. The sulfurous acid 127 may form with a pH range between 0.1 to 2 before the sulfurous acid 127 drops by gravity, without the aid of pressure, into the tank 118. Excess sulfur dioxide 110 may rise out of the tank 118 through a second valve 116 for a second cycle through the second reaction chamber 120 of the sulfur burner system 121. The second cycle allows for more sulfurous acid 127 to form, having a pH range between 1.5 to 3.5, before the sulfurous acid 127 drops by gravity, without the aid of pressure, back into the tank 118. Additional cycles through the sulfur burner system 121 will decrease the pH of the sulfurous acid 127. One or more of the last cycles through the sulfur burner system 121 may include a scrubber system. The scrubber system may have media with many pockets and cavities for creating a greater surface area for a reaction between a stream of H₂O sprayed into the scrubber system with excess sulfur dioxide 110 to form into the sulfurous acid 127. CO₂ may also be collected by the scrubber system.

With a sulfur burner system 121 as outlined, 99% of the starting amount of sulfur may be captured and chemically incorporated into the sulfurous acid 127. Under optimization of reaction conditions, the sulfurous acid 127 in the tank 118 may have a final pH range of between 1.0 to 3.0. The sulfur burner system 121 may burn anywhere between 5 pounds (lbs.) and 50 lbs. of sulfur in an hour. It may take anywhere between several minutes to an hour to introduce the stream(s) of liquid at a rate of anywhere between 50 gallons per minute (gpm) and 250 gpm. With the current sulfur burner system 121, the pH of the resulting sulfurous acid has resulted in a range of between 1.6 to 2.5. In one application, the sulfur burner system 121 may burn about 20 lbs. of sulfur in an hour. At a rate of 50 gallons per minute, it may take about 20 minutes to fill a tank 118 having a 1000-gallon holding capacity with the resulting sulfurous acid 127 having a pH of about 2. In another application, the sulfur burner system 121 may burn about 50 lbs. of sulfur in an hour. At a rate of 250 gallons per minute, it may take about 4 minutes to fill a tank 118 having a 1000-gallon holding capacity with the resulting sulfurous acid 127 having a pH of about 1.6.

As previously discussed, an alkaline liquid used in irrigation may have carbonates and bicarbonates. The carbonates and bicarbonates may be chemically reacted in the reaction chambers 114, 120 with reactants H₂O, oxygen (O) and sulfur dioxide (SO₂) to form the product of H₂SO₃ 127. Reactants H₂O, oxygen (O) and sulfur dioxide (SO₂) may also react with the carbonates and bicarbonates in the alkaline liquid to yield by-products and/or side-products calcium sulfite (CaSO₃), calcium sulfate (CaSO₄) in the case where sulfuric acid (H₂SO₄) is involved, magnesium sulfite (MgSO₃) and magnesium sulfate (MgSO₄) as dissolved salts, carbon dioxide (CO₂) gas, and liquid H₂O. Ratios of the resulting products may depend on factors such as temperature, atmospheric pressure, concentrations and types of minerals within the alkaline liquid. Precipitants in the sulfurous acid 127 will be limited or eliminated due to the chemical reactions and a lowering of the liquid's pH from the sulfur burner application. The resulting sulfurous acid 127 may have little to no precipitates in the form of carbonates and bicarbonates. The CO₂ gas may be exhausted into the atmosphere or captured for beneficial reuse. CaSO₃ and other beneficial salts and sulfur compounds may become soluble and be dissolved into the liquid during the sulfur burner application. As a result, beneficial sulfur and other plant-available nutrients may be incorporated into the liquid fertilizer 147 product. This added benefit gives purpose to using alkaline irrigation water for irrigation in piped systems. For example, calcium sulfate, being a dissolved gypsum salt, loosens the soil structure and may provide other benefits along with the sulfur nutrient when applied to a field 150. Other side reactions and nutrients, such as potassium (K) and phosphorous (P), may be formed during manufacture of the liquid fertilizer 147 and be found beneficial to plants and the soil structure.

The resulting sulfurous acid 127 may be transferred to a liquid fertilizer generator 141. The sulfurous acid 127 may be collected then pumped, or gravity fed, out of a sulfurous acid transfer port 117. The transfer of sulfurous acid 127 may occur by way of an acid source pump 124 of the liquid fertilizer manufacturing system 100. The acid source pump 124 may be a centrifugal pump, a constant delivery pump, a variable delivery pump or other powered pump type. Any pump capable of delivering sufficient load to, or away from, the liquid fertilizer manufacturing system 100 may be utilized. The pump may be powered by any source sufficient to run the pump. A single pump with the appropriate valving may be used or several pumps may be used. The sulfurous acid 127 may be transferred variably by means of a third valve 122 between the sulfurous acid transfer port 117 and the acid source pump 124. When the outlets of the tank 118 and/or reaction chambers 114, 120 are positioned higher than the inlet of the liquid fertilizer generator 141, the sulfurous acid 127 may transfer to the liquid fertilizer generator 141 by the force of gravity.

As shown in FIG. 4, an oxidizing agent 227 may be introduced into the liquid fertilizer manufacturing system 100. The oxidizing agent 227 may be injected at between 1 liter per minute (L/min) to 100 L/min into the liquid fertilizer manufacturing system 100 via fluidly connected oxidizer source 221. The oxidizer source 221 may inject the oxidizing agent 227 at between 15 pounds per square inch (psi) to 75 psi. An oxidizing injection port 225 is configured to introduce the oxidizing agent 227 before or after the liquid fertilizer 147 is produced within the liquid fertilizer manufacturing system 100. The oxidizing agent 227 may be selected from a list of air, oxygen, ozone, 25% hydrogen peroxide, 50% hydrogen peroxide, 75% hydrogen peroxide, 100% hydrogen peroxide, another percentage ratio of an oxidizer, or a combination of oxidizers thereof. The amount of oxidation occurring in the liquid fertilizer 147 may depend on the molecular ratio of the compounds involved. Provision of the oxidizing agent 227 may further enhance a conversion of sulfites to sulfates, which is a desired product, within the liquid fertilizer 147. The liquid fertilizer 147 may have a greater amount or percentage of sulfates where desirable. The presence of a sufficient quantity of an oxidizing agent 227 may result in a complete conversion of sulfites to sulfates. The percentages of sulfites and sulfates within the liquid fertilizer 147 may be determined by chemical analysis testing. In one example, the results may show a liquid fertilizer 147 having 60% sulfates and 40% sulfites. As a result, an oxidizing agent 227 may need introduced to convert the liquid fertilizer 147 into a product having 95% sulfates and 5% sulfites. The chemical analysis results may also help in determining a mass amount or ratio of the oxidizing agent 227. The amount or ratio of the oxidizing agent 227 mixed or introduced into the liquid fertilizer manufacturing system 100 will vary depending upon the chemical analysis results.

For example, a ratio of oxidizing agent 227 to sulfite may be 1:1, where there is a ratio of one molecule of an oxidizing agent 227 to one molecule of sulfurous acid (H₂SO₃). One milligram per liter (mg/L) or part per million (ppm) of ozone, hydrogen peroxide, or a combination of the two may be introduced or mixed for approximately each ppm of sulfite. Another example may be based on mass and include introducing 0.6 grams (g) of 100% ozone or 0.85 grams of 50% hydrogen peroxide solution for approximately each gram of sulfite. The conversion ratios or amounts of oxidizing agent 227 to sulfites may be dependent on temperature, pressure, percent oxygen in the air, and amount or surface area of the oxidizing agent 227 being exposed within the liquid solution. Attribute-based parameters related to the liquid source or sulfurous acid source may be site-specific and necessitate laboratory results to guide the process.

The oxidizing agent 227 may be injected at one point or a plurality of points into the liquid fertilizer manufacturing system 100. The oxidizing agent 227 may be injected into the sulfurous acid 127 prior to the step of injecting the ammonia 137. The oxidizing agent 227 may be introduced before, during, or after the reaction 140. The oxidizing agent 227 may be introduced with the inline or linear type of system previously discussed. In such a system, the oxidizing agent 227 may complete a conversion of sulfites to sulfates within 24 hours of applying the liquid fertilizer from initiating the step of injecting the oxidizing agent 227 into the sulfurous acid.

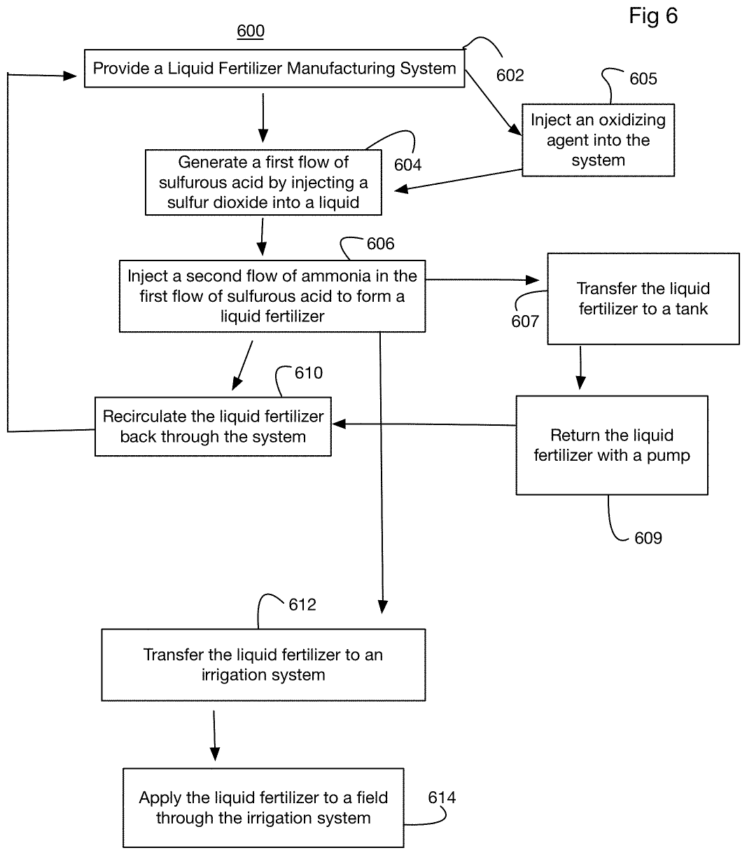

The oxidizing agent 227 may be introduced in a recirculating system. In a recirculating system, the oxidizing agent 227 may be introduced or injected at one oxidizing injection port 225 or a plurality of oxidizing injection ports into the liquid fertilizer manufacturing system 100. The oxidizing agent 227 may be injected or aerated within the tank 118 via the oxidizing injection port 225 during a recirculating step as noted in FIGS. 5 and 6. The recirculating step may occur over a relatively short period, perhaps within 24 hours before the step of applying the liquid fertilizer 147 to a field 150 through the irrigation system 149. Alternatively, the oxidizing agent 227 may be injected or aerated into the tank 118 or another port of the liquid fertilizer manufacturing system 100 over a longer period, perhaps over 14 days before the step of applying the liquid fertilizer 147 to a field 150 through the irrigation system 149. The tank 118 may serve as a holding tank and/or a recirculating tank for the liquid fertilizer 147 by placing the irrigation injection port 146 into a liquid receiving port 119 of the tank 118. In this scenario, the liquid fertilizer 147 may be transferred directly from the liquid fertilizer manufacturing system 100 to the tank 118. The liquid fertilizer 147 in the tank 118 may be sent through the liquid fertilizer manufacturing system 100 via the liquid source pump 104 for a second treatment cycle as previously described. This scenario allows for the liquid fertilizer 147 to become more concentrated with plant nutrients and to further decrease the pH value of the liquid fertilizer 147.

The flow of sulfurous acid 127 into the liquid fertilizer generator 141 may be controlled by way of a fourth valve 126. The sulfurous acid 127 enters the liquid fertilizer generator 141 through a sulfurous acid injection port 125. The sulfurous acid injection port 125 is fluidly connected to the sulfur burner system 121. The sulfurous acid injection port 125 is disposed in an upstream portion 128 of the liquid fertilizer generator 141. The sulfurous acid 127 flows through the liquid fertilizer generator 141 in a downstream direction. The scale dimensions, including breadth, height, length, or volume, of the liquid fertilizer generator 141 may be dimensionally sized to suit a reaction 140 rate.

In one example, the liquid fertilizer generator 141 is a transparent, PVC pipe having dimensions of approximately 6 inches in breadth, 72 inches in length, and a volume of 2,036 cubic inches with valves, connections, gauges, and ports. In another example the liquid fertilizer generator 141 is a non-transparent, PVC pipe having dimensions of approximately 2 inches in breadth, 36 inches in length, and a volume of 452 cubic inches with valves, connections, gauges, and ports. Dimensions of the liquid fertilizer generator 141 may vary based on a volume, amount, or a rate for the reaction 140. Valves may include ball, butterfly, gate, check, needle, pinch, diaphragm, or other feasible valve type. Connections may include flanges, couplings, elbows, and other feasible hose or pipe connection types. Ports may include nipples, flanges, reducers, or other injection or withdraw type ports.

A first sensor or gauge may be placed within the upstream portion 128 to measure pH, temperature, volume rate, or another parameter attribute. The readings may help guide the operator in monitoring and adjusting a reaction 140 within the liquid fertilizer generator 141. A second sensor may be placed in a downstream portion 138 section of the liquid fertilizer generator 141 to perform a different or the same function as the first sensor. Alternatively, the sensor or gauge may be placed at an approximate mid-point of the reaction 140 within the liquid fertilizer generator 141. The reaction 140 may occur where a first input flow of sulfurous acid 127 encounters a second input flow of ammonia 137 within the liquid fertilizer generator 141.

The ammonia 137 may come from an ammonia source 132 selected from a list of anhydrous ammonia (NH₃), a solution of aqueous ammonia, an organic form of ammonia, and ammonia gas such as can be extracted from a deep pit swine house, and a combination thereof. Anhydrous ammonia (NH₃) may be an economical and feasible source of nitrogen for farmers in current agricultural applications. Agricultural applications of NH₃ are not efficient and may result in the loss of 20 to 30% of the applied product due to volatilization to the atmosphere, denitrification by microbes in the soil, and leaching through the soil structure. An advantage realized by operators of the liquid fertilizer manufacturing system 100 is a reduction in these losses. In one example, an ammonia source 132, such as an agricultural anhydrous ammonia tank is transported and connected to the liquid fertilizer manufacturing system 100. Incorporating an NH₃ tank into the liquid fertilizer manufacturing system 100 may be more feasible. The NH₃ may be allowed to flow from the ammonia source 132 through a fifth valve 130. When the fifth valve 130 is opened, the flow of ammonia 137 into the liquid fertilizer generator 141 may be further controlled by way of a sixth valve 134. Pipe diameter size between the valves may be a consideration for the injection pressure of the NH₃.

An ammonia 137 is injected into the acid within a liquid fertilizer generator 141 to form the liquid fertilizer 147. The ammonia 137 may be injected under standard atmospheric pressure at between 1 standard atmosphere (atm) to 5 atm. Injection of the ammonia 137 may be equalized to the atmospheric pressure or injected under pressure at between 15 pounds per square inch (psi) to 60 psi, 30 psi to 75 psi, or 40 psi to 60 psi. The ammonia 137 may enter the liquid fertilizer generator 141 through an ammonia injection port 135 at a rate of between 1 liter per minute (L/min) to 100 L/min. The ammonia injection port 135 may be placed in an upstream portion 128, a downstream portion 138, or other portion of the liquid fertilizer generator 141. The ammonia injection port 135 may be disposed in a downstream portion 138 of the liquid fertilizer generator 141 when orientated vertically as shown in FIG. 1. The ammonia 137 may flow through the sulfurous acid 127 with a counter current flow due to density differentials. A porous air stone or aerator 136 may be used to disperse the ammonia, such as anhydrous ammonia (NH₃), giving the NH₃ a greater surface area for exposure within the descending flow of the sulfurous acid 127.

A counter current flow column configuration may enhance production of ammonium sulfur fertilizer compounds in the liquid fertilizer. Ammonium sulfur fertilizer compounds such as ammonium sulfite (NH₄)₂SO₃ and ammonium sulfate (NH₄)₂SO₄ may be produced in an aqueous solution by circulating ammonia 137 from the bottom up through a shower of sulfurous acid 127 flowing from the top down by the force of gravity. Alternatively, or in combination, ammonium phosphate ((NH₄)₃PO₄) may be formed when phosphoric acid (H₃PO₄) is utilized. In one example, the NH₃ may be introduced at the ammonia injection port 135 between two to five cubic feet per minute (cu ft/min) at atmospheric pressure. This may result in the production of between 10 lbs. to 20 lbs. of ammonia sulfur fertilizer compounds per hour from the liquid fertilizer generator 141, with approximately 5 lbs. of AMS and 15 lbs. of sulfites being produced. In one example, a concentration of AMS of about 1,500 ppm may be produced. The pH of the liquid fertilizer 147 may increase as NH₃ is introduced. To counter the rise in pH, the sulfurous acid 127 may be injected at a pH of about 2. With a system as outlined, up to 20 lbs. of sulfur and 20 lbs. of NH₃ an hour may be injected into the liquid fertilizer manufacturing system 100. In a linear system, a rate of 50 gallons per minute through the liquid fertilizer manufacturing system 100 may process about 10 lbs. of sulfur and 10 lbs. of NH₃ an hour. This may result in about 20 lbs. of ammonia sulfur fertilizer compounds within the liquid fertilizer 147 being produced in an hour. Production of the liquid fertilizer 147 at a given flow rate within the liquid fertilizer manufacturing system 100 may incorporate predetermined amounts of nitrogen and sulfur into the liquid fertilizer 147. The flow rate of the liquid fertilizer 147 may be anywhere between 50 gallons per minute (gpm) to 300 gpm. In one design, the liquid fertilizer manufacturing system 100 may incorporate between 2 lbs. to 50 lbs. of nitrogen and 2 lbs. to 50 lbs. of sulfur into the liquid fertilizer 147 in an hour.

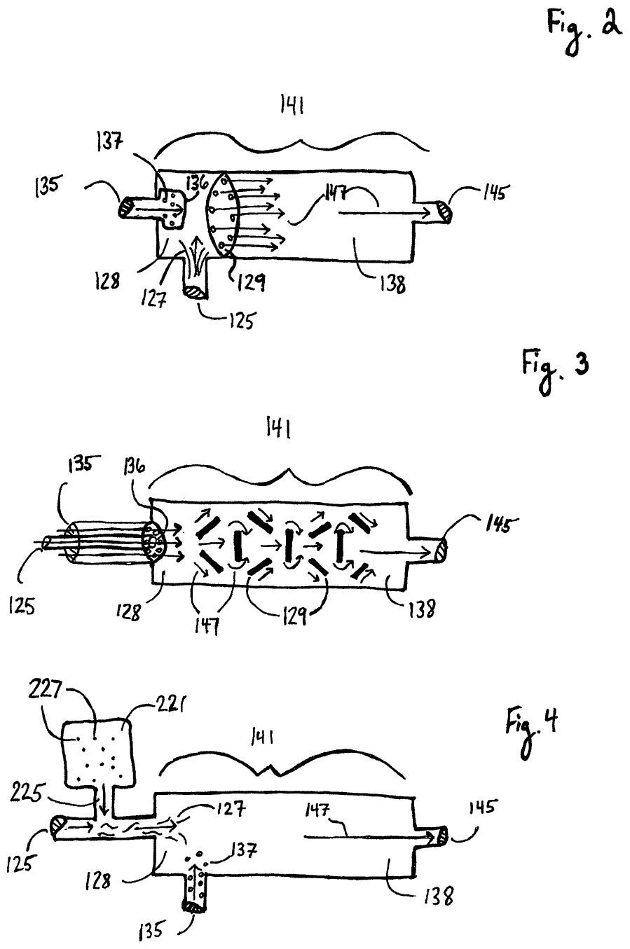

In other scenarios, the liquid fertilizer generator 141 may be orientated at an angle less than vertical. Materials within the liquid fertilizer generator 141 do not necessarily flow by gravity. Forces that move the materials within the liquid fertilizer generator 141 may include, vacuum pressure, flow pressure, head pressure, siphoning, atmospheric pressure differentials, or other means. In one instance, the liquid fertilizer generator 141 is oriented horizontally as shown in FIGS. 2, 3, and 4. The sulfurous acid 127 formed in the reaction chambers 114, 120 may flow by forces of gravity and head pressure to the liquid fertilizer generator 141 and bypass a tank 118. The ammonia injection port 135 is disposed in an upstream portion 128 of the liquid fertilizer generator 141. The ammonia 137 may be injected in an offset direction to a flow of the sulfurous acid 127. The ammonia 137 may flow through the ammonia injection port 135 in an upstream portion 128 of the liquid fertilizer generator 141. The flow path of the sulfurous acid 127 entering the upstream portion 128 may be perpendicular to the flow of the ammonia 137. Alternatively, the ammonia 137 may be injected in a flow direction that is the same as of the sulfurous acid 127 or within the flow of the sulfurous acid 127. Depending on the ammonia source 132, the ammonia 137 that encounters the sulfurous acid 127 may cause a reaction 140 that is delayed or instantaneous. The reaction 140 may happen instantaneously such as when the ammonia 137 is in the form of NH₃. In this instance, an aerator 136 may be used to disperse the NH₃ at an upstream portion 128 within the liquid fertilizer generator 141 for mixing with the sulfurous acid 127.

Alternatively, or in combination, baffles 129 that may be perforated such as an EPDM gasket having a gasket with holes surrounded by a steel encasement may be used for mixing. Baffles 129 may alternate at different angles to create undulating pathways or a labyrinth to disperse and mix the solution of ammonia 137 and sulfurous acid 127 that is aqueous. Baffles 129 may be added when the occurrence of reaction 140 is delayed. To further heighten the occurrence of reaction 140, the liquid fertilizer generator 141 may have media with many pockets and cavities for creating a greater surface area for the sulfurous acid 127 and ammonia 137 to form into the liquid fertilizer 147. Media may consist of a packed bed of plastic media to enhance liquid/gas mass transfer surface area. Other orientations and injection port locations may be realized and found feasible for the liquid fertilizer generator 141.

The liquid fertilizer 147 formed by a reaction 140 from the combination of sulfurous acid 127 and ammonia 137 may be non-biological. The reaction 140 between the sulfurous acid 127 and the ammonia 137 may result in an aqueous solution or liquid fertilizer 147 product having dissolved ammonium sulfur fertilizer compounds with little to no precipitants. An advantage of dissolved ammonium sulfur fertilizer compounds may be an increase in the proportion of nitrogen as ammonium. Another advantage is the liquid fertilizer 147 may have a lowered pH range, from 6 to about 6.5. The background pH range of irrigation water from a well may range from 7.5 to about 8.5. A lowered pH may allow for better plant uptake of nutrients and leaching of salts and nutrients held in the soil structure profile. The amount of sulfur burned within the sulfur burner 108 may be increased or decreased if the pH range of the resulting liquid fertilizer 147 is outside a defined range. When applied to soil of a field 150, soil microbes may help by rapidly converting the ammonium form of nitrogen into a nitrate that is easily taken up by many plants. The dissolved ammonium sulfur fertilizer compounds may also promote an increased uptake of phosphorus, sulfur as a sulfite/sulfate, and other micronutrients. These nutrients may become deliverable in a basic, plant-available form by the dissolved ammonium sulfur fertilizer compounds.

The liquid fertilizer 147 may comprise between 16 ounces (oz.) to 24 oz. ammonium sulfur fertilizer compounds. Ranges for ammonium sulfate may include 4 ounces (oz.) to 6 oz. AMS per gallon liquid fertilizer, 2 oz. to 8 oz. AMS per gallon liquid fertilizer, 4 oz. to 8 oz. AMS per gallon liquid fertilizer, 2 oz. to 6 oz. AMS per gallon liquid fertilizer, 0.5 oz to 5 oz. AMS per gallon liquid fertilizer, 5 oz. to 10 oz. AMS per gallon liquid fertilizer, or 0.5 oz. to 30 oz. AMS per gallon liquid fertilizer. The liquid fertilizer 147 product may have an approximate ratio of nutrients at 5 parts nitrogen to 1 part sulfur as measured at a withdraw port 145 of the liquid fertilizer generator 141. The ratio range may be between 4:1 to 6:1, 4:1 to 8:1, 2:1 to 6:1, 6:1 to 10:1, or 1:1 to 10:1 depending on the intended application. The nitrogen output relative to input may be between 90% to 95%, 95% to 100%, 90% to 100%, 85% to 95%, 75% to 85%, or between 60% to 100%. The liquid fertilizer 147 may comprise between 0.8 ounces (oz.) to 1.3 oz. N per gallon liquid fertilizer, 0.4 oz. to 1.7 oz. N per gallon liquid fertilizer, 0.8 oz. to 1.7 oz. N per gallon liquid fertilizer, 0.4 oz. to 1.3 oz. N per gallon liquid fertilizer, or 0.1 oz to 6.3 oz. N per gallon liquid fertilizer. The sulfur output relative to input may be between 90% to 95%, 95% to 100%, 90% to 100%, 85% to 95%, 75% to 85%, or between 60% to 100%. The liquid fertilizer 147 may comprise between 1 oz. to 1.4 oz. S per gallon liquid fertilizer, 0.5 oz. to 1.9 oz. S per gallon liquid fertilizer, 1 oz. to 1.9 oz. S per gallon liquid fertilizer, 0.5 oz. to 1.4 oz. S per gallon liquid fertilizer, 0.1 oz to 1.2 oz. S per gallon liquid fertilizer, 1.2 oz. to 2.4 oz. S per gallon liquid fertilizer, or 0.1 oz. to 7.2 oz. S per gallon liquid fertilizer.

The liquid fertilizer 147 may be drawn from the liquid fertilizer generator 141 at the withdraw port 145 by the force of gravity, vacuum pressure, flow pressure, siphoning, atmospheric pressure differentials, pump pressure, or by other means. The pressure of the liquid fertilizer 147 at the withdraw port 145 may be near 0 pounds per square inch (psi) when flow is induced by the force of gravity. The liquid fertilizer 147 may flow from the withdraw port 145 of the liquid fertilizer generator 141 at a rate between 10 gallons per minute (gpm) to 1000 gpm. The withdraw port 145 may be fluidly connected to the irrigation system via the irrigation injection port 146. A seventh valve 142 may be used to adjust the amount of liquid fertilizer 147 flow from the liquid fertilizer generator 141 to the irrigation system. A liquid fertilizer pump 144 may be used to transfer the liquid fertilizer 147 from the liquid fertilizer generator 141 to the irrigation system. A sensor may be placed within or downstream of the withdraw port 145 to monitor an amount or percentage of nitrogen, other fertilizer nutrient proportions, along with pH, temperature, and other attribute-based parameters. The sensor may be tied to a controller on or within the withdraw port 145 of the liquid fertilizer generator 141 to control how much liquid fertilizer 147 is being applied to a field 150 or portion thereof, such as between 10-to-20-acre units. In one example, the sensor and controller may automatically adjust the application amount so a 10-acre unit of the field 150 receives approximately 50 lbs. of nitrogen per acre through the irrigation system.

As shown in FIG. 5, The tank 118, or a plurality of tanks, may allow liquid fertilizer produced from the liquid fertilizer generator 141 to have further residence time, act as a holding tank for the liquid fertilizer until transferred to the irrigation system 149, or be connected to the liquid fertilizer manufacturing system 100 so the liquid fertilizer is recycled through the system. A tank 118 used as storage retention for a reaction 140 may be fluidly connected to an input side of the sulfur burner system 121 to recirculate the liquid fertilizer 147 generated back through the liquid fertilizer manufacturing system 100. Recirculated flow increases sulfurous acid 127 concentrations. Recirculated flow may be separately introduced into the liquid fertilizer manufacturing system 100 or combined with the flow of liquid introduced from the liquid source 102.

The withdraw port 145 of the liquid fertilizer generator 141 may be redirected back to a liquid receiving port 119 of the tank 118. The tank 118 used as storage retention for a reaction 140 of the liquid fertilizer 147 may be fluidly connected to the withdraw port 145 of the liquid fertilizer generator 141. This may also allow for recirculation of the liquid fertilizer 147 within the liquid fertilizer manufacturing system 100 to become more concentrated with nitrogen. Alternatively, the withdraw port 145 of the liquid fertilizer generator 141 may become the liquid source 102 for the liquid fertilizer manufacturing system 100 to become more concentrated with sulfur and/or nitrogen. Recirculation may increase nutrient concentrations within the liquid fertilizer 147 or further lower the pH. Setup as a recirculation type system may reduce input costs allowing the ammonium sulfur fertilizer compounds to be made more cheaply with a higher concentration.

As shown in FIG. 5, the liquid fertilizer may be diluted within a total volume of irrigation water applied to a field 150. Dilution of the liquid fertilizer within the total volume of irrigation water may be anywhere between 15% to 75%. Liquid drawn from the liquid source 102 may be split and directed to both the liquid fertilizer manufacturing system 100 and the irrigation system 149 with another pump and T-pipe system and then combined for remixing of the two streams. In such a scenario, the liquid fertilizer formed is mixed with the liquid source water that was contrived to form the liquid fertilizer. This may allow for an increase in the total volume of irrigation water. Additionally, the ratio of liquid fertilizer to irrigation water may be controlled. An operator may draw between 50 gallons per minute (gpm) to 1,500 gpm of a liquid from a liquid source 102, such as an on-site water well. In one example, where 500 gpm of a liquid is drawn from the liquid source 102, 100 gpm of the liquid may be directed to the liquid fertilizer manufacturing system 100 before entering the irrigation system 149. The other 400 gpm of the liquid may be directed to the irrigation system 149. 80 gpm of the liquid directed to the liquid fertilizer manufacturing system 100 may be recirculated back through the sulfur burner system 121 before entering the liquid fertilizer generator 141. In this scenario, the sulfurous acid 127 may be recycled back through the sulfur burner system 121 to decrease the pH and increase the sulfur percentages within the sulfurous acid 127. In another example, 1500 gpm of a liquid may be drawn from the liquid source 102. 300 gpm of the liquid may be directed through the liquid fertilizer manufacturing system 100 before entering the irrigation system 149. The other 1,200 gpm of the liquid may flow directly to the irrigation injection port of the irrigation system 149 where the 300 gpm of liquid fertilizer produced eventually combines.

Alternatively, the total liquid directed through the liquid fertilizer manufacturing system 100 may be processed and recirculated back through the start of the liquid fertilizer manufacturing system 100 before entering the irrigation system 149. A tank 118 having a volume of 500 gallons may be provided on site to hold the liquid fertilizer 147 produced before applying the liquid fertilizer 147 to a field 150 by the irrigation system 149. As discussed previously, the tank 118 may provide the liquid fertilizer 147 further residence time to complete a reaction 140. The tank 118 may be used to store the liquid fertilizer 147 until used by the irrigation system 149. The tank 118 may be used to hold the liquid fertilizer 147 until recycled through the liquid fertilizer manufacturing system 100. This may allow the lowering of pH concentrations or adjustments to nutrient parameters of the liquid fertilizer 147 when passed through the liquid fertilizer manufacturing system 100 multiple cycles. The schematic plan view in FIG. 5 is just one representation of the many operational modes, designs, and stream flow paths that may be recognized in the use of the liquid fertilizer manufacturing system 100 and process.

In one example, the liquid fertilizer manufacturing system 100 may be a small portable unit 148 used with flood irrigation furrows, a pivot irrigation system, a subsurface drip irrigation system, or other sprinkler type irrigation system. At a field 150 with a pivot irrigation system, the liquid fertilizer manufacturing system 100 may produce approximately 5 lbs. of AMS and 15 lbs. of ammonium sulfite per acre over an approximately one day period of irrigation. In another example, about 15 lbs. of AMS per acre over an approximately 3-day period may occur. In that period, the pivot irrigation system may have made a complete revolution 151 dispensing about an inch of water over the field 150. This may equate to about 700 gpm of the liquid fertilizer 147 being broadcast over the complete revolution 151 of the irrigation circle. A pivot irrigation system may typically run from anywhere between 500 gpm to 1000 gpm up to 1,500 gpm. In another instance, the liquid fertilizer manufacturing system 100 may be a large stationary unit used at an operator's shop. In a recirculation configuration, the liquid fertilizer manufacturing system 100 may produce enough concentrate for application in 20 to 30 pivot irrigation systems. In this setup, the operator may provide an anhydrous ammonia tank or other ammonia source 132 on an interval about every six hours. This may result in the need to burn up to 20 times the amount of sulfur than a liquid fertilizer manufacturing system 100 that is smaller. About 1000 gallons of liquid fertilizer 147, with aqueous ammonium sulfate being about 50% of the concentrate, may be produced at this rate. The liquid fertilizer 147 may be placed in a transport tank and dispensed into tank 118, in which the liquid fertilizer 147 is pumped into the irrigation system.

As shown in FIG. 6, a method 600 for applying a liquid fertilizer is presented. A liquid fertilizer manufacturing system 100 is provided to form the liquid fertilizer 147, according to step 602. The liquid fertilizer manufacturing system 100 generates a sulfurous acid 127 via a fluidly connected sulfur burner system 121 or sulfurous acid source 111, according to step 604. Alternatively, the source of acid may be purchased and transported to the tank 118 as previously described. The liquid fertilizer manufacturing system 100 may be fluidly connected to an oxidizer source 221. An oxidizing agent 227 may be injected into the liquid fertilizer manufacturing system 100, according to step 605. An oxidizing injection port 225 may be configured to introduce the oxidizing agent 227 before or after the liquid fertilizer 147 is produced within the liquid fertilizer manufacturing system 100. An ammonia 137 is injected into the sulfurous acid 127 within a liquid fertilizer generator 141 to form the liquid fertilizer 147, according to step 606. The liquid fertilizer 147 may be transferred from the liquid fertilizer generator 141 to a tank 118, according to step 607. The purpose for this step may be to retain the liquid fertilizer 147 until transferred to the irrigation system 149, for retention purposes in completing a reaction 140, or for a recirculating step where the liquid fertilizer 147 is sent back through the system, according to step 610. The liquid fertilizer 147 may be returned for the recirculation step by a liquid fertilizer pump 144, according to step 609. Alternatively, the liquid fertilizer pump 144 may be used to transfer the liquid fertilizer 147 to an irrigation system 149, according to step 612. The liquid fertilizer 147 is then applied to the field 150 by the irrigation system, according to step 614.

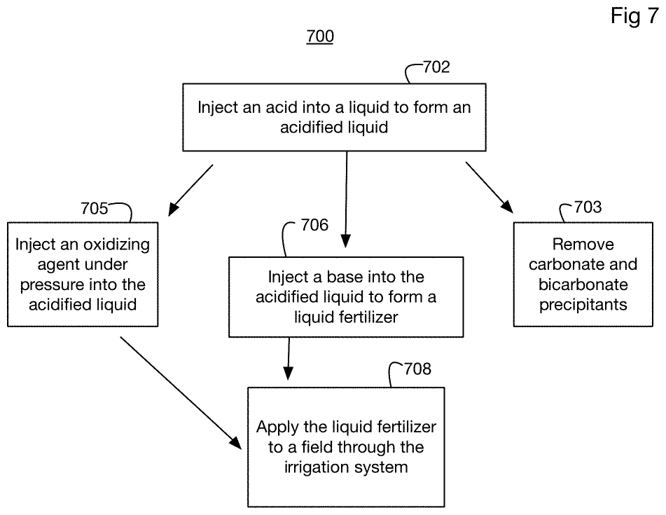

As shown in FIG. 7, a method 700 for making a liquid fertilizer 147 is presented. A liquid source 102 may be provided to form the liquid fertilizer 147. The liquid source 102 may provide a liquid that is alkaline. The alkaline liquid may contain carbonates and bicarbonates that become dissolved into solution when injecting an acid into the liquid, according to step 702. Any precipitation or mineral deposits from the liquid fertilizer 147 passing through the irrigation system may be eliminated or limited, according to step 703. The acidified liquid is injected with a base, such as an ammonia to form the liquid fertilizer 147, according to step 706. An oxidizing agent may be injected into the acidified liquid before or after the base is injected, according to step 705. The liquid fertilizer 147 is applied to the field 150 through the irrigation system, according to step 708.

The liquid, acid, ammonia, and ultimately the liquid fertilizer 147 may be transferred through a collection of pumps, pipes, or hoses made of material such as metal, plastic, glass, rubber, or tubular material. Plastic pipe may be made of low- or high- density polyethylene, polytetrafluorethylene, or ultra-high molecular weight polyethylene, polyvinyl chloride (PVC), or other material that provides impact, chemical, abrasion, with moisture-resistance and a low-friction surface. It is also contemplated that no pump is necessary when the liquid is gravity fed or the system is pressurized. An elevated tank may be employed to provide sufficient flow of the liquid to the liquid fertilizer manufacturing system 100. The system may utilize other means to provide sufficient liquid pressure and flow. Forces used to move the liquid may include, vacuum pressure, flow pressure, head pressure, siphoning, or atmospheric pressure differentials.

It is understood that the invention is not confined to the particular construction and arrangement of parts herein described. That although the drawings and specification set forth a preferred embodiment, and although specific terms are employed, they are used in a description sense only and embody all such forms as come within the scope of the following claims.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed variations, modifications and variations are within the literal scope of the following claims, and others are equivalent.

We claim:

1. A method for applying a liquid fertilizer comprising the steps of:
a. providing a liquid fertilizer manufacturing system connected to an irrigation system;
b. injecting an ammonia gas with an aerator into an acid to form the liquid fertilizer within the liquid fertilizer manufacturing system;
c. transferring the liquid fertilizer from the liquid fertilizer manufacturing system to the irrigation system; and
d. applying the liquid fertilizer to a field through the irrigation system.

2. The method of claim 1, further comprising the step of:
a. injecting an oxidizing agent at between 1 liter per minute to 100 liters per minute into the acid prior to the step of injecting the ammonia.

3. The method of claim 1, further comprising the step of:
a. recirculating the liquid fertilizer from a liquid fertilizer generator back through the liquid fertilizer manufacturing system.

4. The method of claim 3, further comprising the steps of:
a. transferring the liquid fertilizer from the liquid fertilizer manufacturing system to a tank; and
b. returning the liquid fertilizer from the tank to the liquid fertilizer manufacturing system with a pump.

5. The method of claim 1, wherein the ammonia is sourced from an anhydrous ammonia tank.

6. The method of claim 1, wherein the liquid fertilizer formed by a reaction in the liquid fertilizer manufacturing system is non-biological.

7. The method of claim 1, wherein the liquid fertilizer manufacturing system is fluidly connected to the irrigation system with a pump.

8. The method of claim 7, wherein the liquid fertilizer manufacturing system is configured to generate the liquid fertilizer at a flow rate of between 50 gallons per minute and 300 gallons per minute for application through a pivot irrigation system at a flow rate of between 50 gallons per minute and 1500 gallons per minute.

9. The method of claim 1, further comprising the step of:
a. generating the acid within the liquid fertilizer manufacturing system by injecting a sulfur dioxide into a liquid.

10. The method of claim 1, wherein the liquid fertilizer manufacturing system is a portable unit.

11. The method of claim 1, wherein the liquid fertilizer is applied less than 24 hours from initiating the step of injecting the ammonia gas into the acid.

12. The method of claim 1, wherein the ammonia gas is injected at between two to five cubic feet per minute into a first flow of the acid.

13. The method of claim 12, wherein the first flow of acid is injected into the liquid fertilizer manufacturing system in the same direction as a second flow of the ammonia gas.

14. The method of claim 1, wherein the ammonia gas is injected at between 15 pounds per square inch to 75 pounds per square inch with an air stone fluidly connected to an ammonia injection port.

15. The method of claim 1, further comprising the steps of:
a. directing a first flow of the acid through a liquid fertilizer generator in a downstream direction; and
b. directing a second flow of the ammonia gas through the liquid fertilizer generator within the first flow of the acid.

16. A method for applying a liquid fertilizer comprising the steps of:
a. generating a flow of alkaline water;
b. acidifying the flow of alkaline water with a sulfur burner to generate a flow of acidified water;
c. injecting gaseous ammonia into the flow of acidified water to generate a flow of liquid fertilizer; and
d. applying the liquid fertilizer to a field, wherein the flow rate of the liquid fertilizer is between 50 gallons per minute and 300 gallons per minute.

17. A method for applying a liquid fertilizer comprising the steps of:
a. providing a flow of alkaline water to a liquid fertilizer manufacturing system;
b. acidifying the flow of alkaline water within a reaction chamber to generate a flow of acidified water, where the reaction chamber is fluidly connected to a sulfur burner;
c. injecting gaseous ammonia into the flow of acidified water to generate a flow of liquid fertilizer; and
d. applying the liquid fertilizer to a field, wherein the flow rate of the liquid fertilizer is between 50 gallons per minute and 300 gallons per minute.

18. The method of claim 17, wherein the liquid fertilizer manufacturing system is portable.

19. The method of claim 17, wherein the liquid fertilizer is applied to the field less than 24hours from initiating the step of injecting gaseous ammonia into the flow of acidified water.

20. The method of claim 17, wherein the gaseous ammonia is injected counter current to the flow of the acidified water.
